(19) United States
(12) Patent Application Publication
(10) Pub. No.: US 2007/0269697 A1
(43) Pub. Date: Nov. 22, 2007

(54) Solid Electrolyte Fuel Cell

(75) Inventors: Vincent Randon, Ville D'Avray (FR); Damien Lemasson, Villeurbanne (FR); Guillaume Joncquet, Paris (FR); Patrick Le Gallo, Jarrie (FR)

Correspondence Address: NICOLAS E. SECKEL;Patent Attorney, 1250 Connecticut Avenue, NW Suite 700, WASHINGTON, DC, 20036, US

(73) Assignees: PEUGEOT CITROEN AUTOMOBILES SA, Velizy-Villacoublay (FR); COMMISSARIAT A L'ENERGIE ATOMIQUE, Paris (FR)

(21) Appl. No.: 11/569,043

(22) PCT Filed: May 9, 2005
(86) PCT No.: PCT/FR05/01148

§ 371 Date: Jul. 6, 2007

(30) Foreign Application Priority Data
May 12, 2004 (FR) 04 05150

(51) Int. Cl. H01M 8/02

(52) U.S. Cl. 429/26

(57) ABSTRACT

A solid electrolyte fuel cell comprising an electrode-membrane (5) unit disposed between two bi-polar plates (3) and (4), also comprising at least one electroconductive cross-member (6) arranged between one of the bi-polar plates (4) and the electrode-membrane unit (5) in order to keep the bipolar plates at a distance, wherein the electrode membrane unit (5) is configured in such a way that it can divide the area (10) defined by the bi-polar plates into at least one channel for the passage of a first gas (8) and at least one channel for the passage of a second gas (9). Fuel cell consisting of a cell stack.

The present invention relates to a solid-electrolyte fuel cell.

Solid-electrolyte fuel cells are electrochemical devices for producing electricity, being constituted by a stack of individual cell that are fed with reagent gases and in which a chemical reaction takes place that is accompanied by the production of electricity and the release of heat. An individual cell is made up of a “membrane electrode assembly” (MEA) interposed between two bipolar plates. The membrane electrode assembly is constituted by a proton-conductive polymer membrane acting as an electrolyte, having thickness lying in the range 20 micrometers (μm) to 200 μm, clamped between two porous electrodes, each of which is constituted by an active layer (of porous carbon supporting a platinum electrocatalyst) deposited on a diffusion layer (a substrate of paper or carbon fabric). The two bipolar plates serve to collect electricity and distribute the reagent gases and a cooling fluid. The reagent gases comprise firstly hydrogen which is applied to a first side of the membrane electrodes assembly, and secondly oxygen or air which is applied to the other side of the membrane electrode assembly. When the two bipolar plates are electrically connected in contact with the membrane electrode assembly, the hydrogen decomposes into electrons that are collected by the corresponding bipolar plate which becomes an anode, and into hydrogen ions (H⁺) that diffuse through the membrane electrode assembly. The oxygen which is applied to the other side of the membrane electrode assembly reacts with the H⁺ ions, and with electrons that are supplied by the associated bipolar plate, which thus becomes a cathode, thereby producing water. These reactions generates an electronic current that flows through the electrical connection between the two bipolar plates. The electric current can then be used for various purposes. The heat of the reaction is removed by cooling water flowing in the bipolar plates.

In a well-known embodiment, the bipolar plates are constituted by thick graphite plates having ribs machined therein for forming the gas flow channel and the cooling fluid flow channels. The membrane electrode assembly is sandwiched between two bipolar plates so as to constitute an individual cell for a fuel cell. A plurality of individual cell for a fuel cell are stacked so as to form a fuel cell. The bipolar plates of two adjacent individual cells then come into contact with each other. The shape and the quality of the machining of the graphite plates is such that contact between the bipolar plates of two adjacent cells take place over a large area with pressure that is uniform so as to ensure good electrical contact. That technique presents the drawback of being expensive and of leading to fuel cells that are bulky, in particular because of the thicknesses needed for a single individual cell, which thickness are of the order of 5 millimeters (mm) to 1 centimeter (cm).

In order to reduce the cost of architectures for that type of fuel cell, proposals have been made to use stainless steel sheets instead of graphite plates. In such an embodiment, the gas flow channels and the cooling circuit are constituted by ribs formed by folding or stamping the stainless steel sheets. The technique is less expensive than the preceding technique but nevertheless presents the drawback of being difficult to implement, in particular because of the difficulties in making channels of complex shapes and channels of good dimensional accuracy, as is necessary in order to obtain good electrical contact, and thus good efficiency for the fuel cell.

The object of the present invention is to remedy those drawbacks by proposing an architecture for a solid-electrolyte fuel cell that is less expensive to make than are the architectures of fuel cells having bipolar plates made of graphite, and that leads to better dimensional quality and thus better electrical contact than with fuel cells in which the bipolar plates are stainless steel sheets shaped by folding and stamping.

To this end, the invention provides a cell for a solid-electrolyte fuel cell of the type comprising a membrane electrode assembly disposed between two bipolar plates, further comprising at least one electrically-conductive spacer disposed between one of said bipolar plates and the membrane electrode assembly in such a manner as to hold the bipolar plates apart, and the membrane electrode assembly being shaped so as to subdivide the space defined between the bipolar plates into at least one channel for passing a first gas and at least one channel for passing a second gas.

Preferably, the at least one spacer is a tube for receiving a cooling fluid.

The membrane electrode assembly may be corrugated, the at least one spacer being parallel to the corrugations so as to allow at least one gas to flow parallel to the spacer.

At least one spacer may also include, in its face for co-operating with bipolar plate, at least one indentation so as to provide a lateral passage for a gas, thus enabling a first gas to flow parallel to the spacer and the second gas to flow perpendicularly to the spacer.

The at least one spacer may include in its face for co-operating with the membrane electrode assembly, at least one indentation so as to provide a lateral passage under the spacer, and the active membrane is shaped in such a manner as to co-operate with the at least one indentation so as to enable one gas to flow parallel to the spacer and enable the other gas to flow perpendicularly to the spacer. The membrane electrode assembly then includes at least one indentation in one direction and an indentation in a perpendicular direction so as to allow the gas flowing perpendicularly to the spacer to spread out in a space that extends parallel to spacer in such a manner as to maximize the contact area of the gas with the membrane electrode assembly.

Preferably, the membrane electrode assembly is shaped so as to create a plurality of gas flow channels.

Preferably, the bipolar plates are plane and are constituted by respective sheets of an electronically-conductive metal, e.g. a stainless steel.

The invention also provides a solid-electrolyte fuel cell comprising at least one fuel-cell cell of the invention, together with means for clamping the at least one fuel-cell cell perpendicularly to its surface, so as to provide satisfactory electrical contact at the points of contact between the bipolar plates, the spacers, and the cell.

In addition, the solid-electrolyte fuel cell may include, for example: a peripheral frame provided with channels for allowing a first gas to flow and channels for allowing a second gas to flow, said gas-flow channels opening out into the corresponding gas-flow spaces in the cells of the fuel cell, and also cooling-fluid-flow channels opening out into the tubular spacers of the cells of the fuel cell.

The invention is described below in greater detail but in non-limiting manner with reference to the accompanying figures, in which:

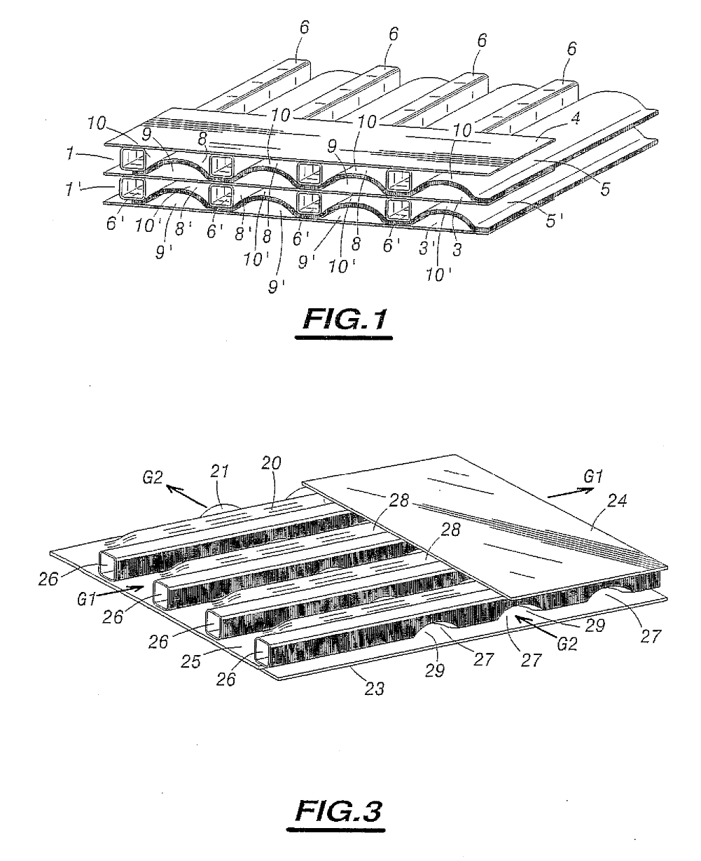

FIG. 1 is a cutaway fragmentary perspective view of a stack of two individual cells in a solid-electrolyte fuel cell, in a first embodiment;

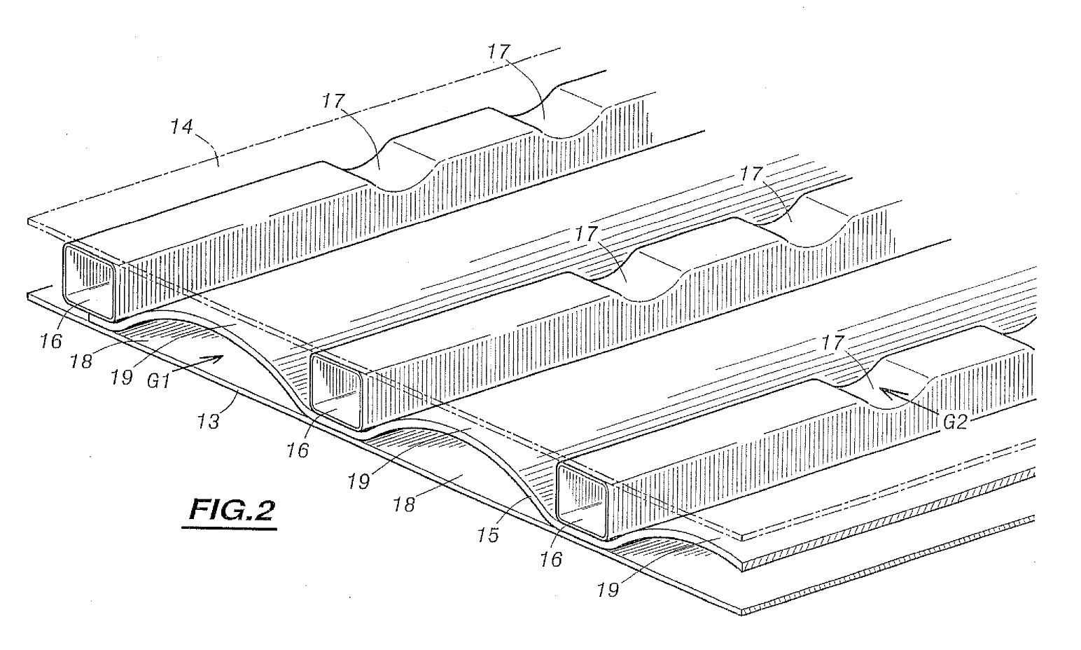

FIG. 2 is a cutaway fragmentary perspective view of an individual cell in a solid-electrolyte fuel cell in a variant of the first embodiment;

FIG. 3 is a cutaway fragmentary perspective view of a second embodiment of an individual cell in a solid-electrolyte fuel cell;

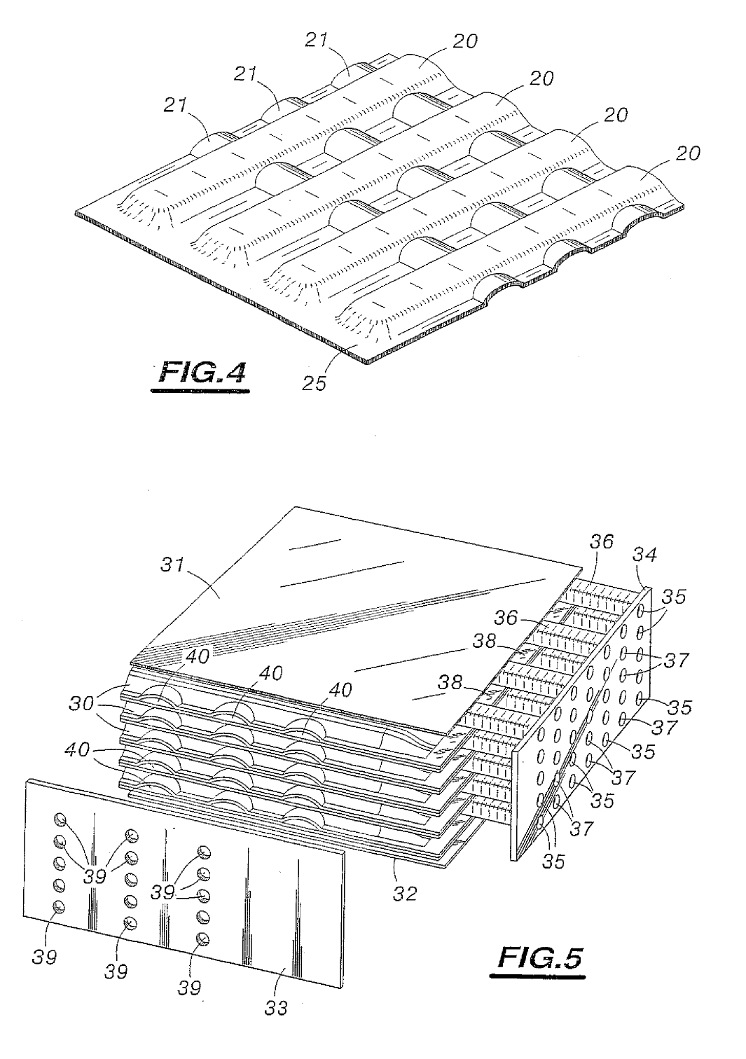

FIG. 4 is a fragmentary perspective view of a membrane electrode assembly (MEA) for an individual cell in a solid-electrolyte fuel cell of the second embodiment of the invention; and

FIG. 5 is a fragmentary perspective view of a stack comprising a plurality of individual cell for a solid-electrolyte fuel cell with side plates for closing the fuel cell.

FIG. 1 shows a stack of two individual cells 1 and 1′ of a fuel cell in a first embodiment. Each individual cell 1 or 1′ of the generally-rectangular solid-electrolyte fuel cell is constituted by a stack comprising, going upwards from the bottom for the individual cell 1: a first plane plate 3 of stainless steel; a membrane electrode assembly (MEA) 5; mutually-parallel tubular spacers 6 extending in a longitudinal direction of the cell, and spaced apart so as to leave an empty space 8 available between two adjacent spacers; and a second plane plate 4 of the stainless steel resting on the spacer 6. In register with each spacer 6, the membrane electrode assembly 5 is pinched between the corresponding spacer and the first stainless steel plate 3. Between two adjacent spacers 6, the membrane electrode assembly 5 is corrugated so as to subdivide the space 8 between the spacers 6 into two spaces 9 and 10 situated on either side of the membrane electrode assembly and serving to allow active gases to flow. By way of example, the space 9 situated between the first stainless steel plate 3 and the membrane electrode assembly 5 constitutes a channel suitable for receiving hydrogen gas, while the space 10 constitutes a channel suitable for receiving air. The hydrogen flowing in the channel 9 and the air or oxygen from the air flowing in the channel 10 react through the membrane electrode assembly 5, with electrons that are generated by decomposition of the hydrogen being collected by the stainless steel plate 3 and with the electrons needed for combining hydrogen ions and oxygen being brought into contact with the membrane electrode assembly 5 via the stainless steel plate 4 and the spacers 6. It should be observed that the opposite configuration, i.e. hydrogen flowing in the channel 9 and air flowing in the channel 8 is also possible. The spacers 6 are tubes and they convey a cooling fluid, e.g. water.

The individual cell 1′ adjacent to the individual cell 1 is made up of in the same manner of a stainless steel plate 3 resting on the spacers 6′ which bear against the membrane electrode assembly 5′, itself in contact with a second stainless steel plate 3′. In the same manner as for the cell 1, the membrane electrode assembly 5 is corrugated so as to define spaces 9′ and 10′ between the spacer 6′ for flows both of hydrogen and of air. In this disposition, the stainless steel plate 3 is common to both individual cells 1 and 1′. When a plurality of individual cells are stacked one on another, the stainless steel plates 3, 3′, or 4 are common to pairs of adjacent cells. This disposition presents the advantage that contacts between the stainless steel plates 3, 3′, or 4 the spaces 6 or 6′, and the membrane electrode assemblies 5 and 5′ take place along the rectilinear side faces of the spacers 6 and 6′. By means of this disposition, bipolar plates having good electrical contacts can be obtained using flexible stainless steel plates 3, 3′, and 4, without any need for them to be especially plane. The membrane electrode assembly (MEA) may either be preformed so as to provide the corrugations, or else it may be corrugated during the assembly process, using jigs that are subsequently removed, once the spacers have been put into place. In membrane electrode assembly (MEA) are shaped by using one gas at a pressure that is higher than that of the other.

In order to make a fuel cell, a plurality of cells of the kind described above are stacked together. To do this, a stainless steel sheet is put into place initially, followed by a membrane electrode assembly (already formed, or formed using jigs), and then the spacers are put into place with a second stainless steel sheet being placed thereon, on which another membrane assembly is placed, followed by spacers, and then another stainless steel sheet, and so on.

Once the stack of individual cells has been built up, it is placed between a top closure plate and a bottom closure plate, and the stack is clamped between the two closure plates so as to ensure a defined level of contact pressure between the spacers and the bipolar plates. The assembly is then placed in a frame (not shown) having openings for admitting and exhausting the reagent gases and for admitting and exhausting the cooling fluid. The admission and exhaust openings for each gas or for the cooling fluid are placed in register with the channels in which said gas or fluid is to flow. The closure plates and the frames are not described in detail since, for example, they may be identical to those used in prior art fuel cells and the person skilled in the art knows how to make them without difficulty.

A fuel cell can thus be built up from materials that are inexpensive such as sheets of stainless steel instead of using plates of graphite, and there is no need to use special means for guaranteeing tight tolerances. This makes it possible to achieve significant cost savings. This method of making a fuel cell also avoids the risks inherent to shaping stainless steel plates, and it guarantees good electrical contact in the stack. The quality of this electrical contact also serves to increase the efficiency of the fuel cell. Finally greater compactness can be obtained since the thickness of each cell can be reduced. Compared with embodiments know in the prior art, it is possible to use stainless steel sheets of small thickness, thereby enabling the cells to be reduced in thickness by about 5%. The contact area between the gases and the membrane electrode assemblies is increased, thereby increasing the specific power of the fuel cell. Finally, at the edges of the individual cells that are parallel to the spacers, the membrane electrode assemblies can be flattened against the stainless steel sheets, thus enabling a gasket function to be provided.

In a second embodiment shown in FIG. 2, the individual cell is constituted, as above, by a stainless steel plate 13 having a membrane electrode assembly 15 placed thereon that is corrugated in a longitudinal direction, and by a second plane stainless steel plate 14 disposed on spacers 16 resting on those portions of the membrane electrode assembly that are in contact with the first stainless steel plate 13. Each spacer 16 includes indentations 17 provided in its face that is to come into contact with the second stainless steel plate 14.

The membrane electrode assembly 15 subdivides the space situated between the two plane stainless steel plates 13 and 14 into gas flow spaces 18 and 19.

The spaces 18 situated between the plane plate 13 and the membrane electrode assembly 15 are channels that extend parallel to the spacers 16 and allow gas to flow in the direction represented by arrow G1, parallel to the spacers 16. The spacers 19 defined by the membrane electrode assembly 15, by two adjacent spacers, and by the second stainless steel plate 16, which communicate with one another via the indentations 17. As a result, the second gas can flow in a direction represented by arrow G2 that is perpendicular to the flow direction of the first gas.

This disposition has the advantage of clearly separating the admission and exhaust means for each of the gases.

In a third embodiment shown in FIG. 3, the individual cell is constituted by a first plane plate 23 of stainless steel having placed thereon a membrane electrode assembly 25 having the shape shown in FIG. 4. A plurality of mutually-parallel tubular spacers 26 are disposed on the membrane electrode assembly 25. A second plane plate 24 of stainless steel rests on the tubular spacers 26. The membrane electrode assembly 25 shown in FIG. 4 is shaped in such a manner as to have a grid structure constituted by a first series of longitudinal indentations 20 parallel to a first direction of the membrane electrode assembly 25, and a second series of indentation 21 extending transversely, parallel to a second direction of the membrane electrode assembly, perpendicular to the first direction. The indentations of the first series of indentations 20 extend over the entire length of the membrane electrode assembly, but each of them is closed at both ends. The transverse indentations 21 are of smaller height than the longitudinal indentations 20 and they extend over the entire width of the membrane electrode assembly, opening out into the edges of the membrane electrode assembly. The spacers 26 include indentations 27 that are complementary in shape to the transverse indentations 21 of the membrane electrode assembly. As a result, the spacers 26 placed between two longitudinal indentations 20 of the membrane electrode assembly 25 fit on the transverse indentations 21 of the membrane electrode assembly and thus leave these transverse indentations 21 free to pass gas in the transverse direction represented by arrow G2. In this embodiment, the spaces left empty between two spacers 26, the membrane electrode assembly 25, and the second stainless steel plate 24 constitute the channels 28 allowing a gas to flow in a direction represented by arrow G1. The spaces available between the transverse indentations 21 of the membrane electrode assembly and the bottom stainless steel plate 23 constitute lateral flow channels 29 for passing a second gas in a direction perpendicular to the first direction and referenced G2. As in the above-described embodiment, this disposition has the advantage of enabling the admission and exhaust points for the first gas to be separated from the admission or exhaust point for the second gas. In addition, since the gas flowing in the transverse channel 29 can spread under the longitudinal indentations 20, the contact area of the gas with the membrane electrode assembly is maximized. In this disposition, one of the gases flows in generally linear channels in a direction corresponding to arrow G1, while the second gas flows in a flow space that includes dead end zone. As a result, it is preferable for the generally rectilinear channels to be fed with the gas that will react to form water, i.e. air, or more generally the gas that contains oxygen. The channels having shapes that include dead ends are then fed with hydrogen gas.

In the three embodiments described above, the electrode assembly of any one individual cell in the fuel cell is pinched between a single plane plate of stainless steel and a set of spacers. In other words, all of the spacers lie on the same face of the membrane electrode assembly. However other dispositions could be envisaged, for example the membrane electrode assembly could be pinched both between a first stainless steel plate and every other spacer, and between the second stainless steel plate and the intermediate spacers.

Whatever the particular shape of the membrane electrode assembly and the way in which it is clamped between the spacers and the plane stainless steel plates, it is possible to make a stack of individual cells so as to build up a fuel cell. The stack is obtained by placing a membrane electrode assembly and spacers on a first stainless steel plate, then covering that with a second plane stainless steel plate, and then again placing a membrane electrode assembly and spacers on the second plane stainless steel plate and covering that with a third plane stainless steel plate, and so on.

The resulting stack is placed between two closure plates and is clamped between these plates so as to ensure satisfactory electrical contact between the plane stainless steel plates, between the spacers and the membrane electrode assemblies.

For the contact to be satisfactory, it suffices for the plane stainless steel plates to be sufficiently thin to provide suitable flexibility.

An example of a stack of individual cells is shown diagrammatically in FIG. 5, in which there can be seen only one-fourth of a stack of individual cells. In this example, the individual cells 30 are clamped between two end plates 31 and 32 by clamping means (not shown) that may be of any type and that the person skilled in the art knows how to provide. The individual cells are of the type allowing fluid to flow along crossed paths, as described above. The side faces of the stack of individual cells are constituted by four side plates (only two of which can be seen in part in the figures). These side plates comprise firstly plates 33 parallel to the spacers 36 and including holes 39 opening out into the flow channels 40 for a first gas, and secondly plates 34 perpendicular to the plates 33 and including holes 3 opening out into the insides of the spacers 36 so as to enable the cooling fluid to be caused to flow therealong, and holes 35 opening out into the channels 38 of the individual cells, in order to enable the second reagent gas to flow. In the embodiment shown, the spacers 36 are secured to the side plates 34. However such a configuration is not essential. The assembly is assembled and sealing is provided by gaskets (not shown) that the person skilled in the art knows how to make.

The reader will understand that it is possible to use any dispositions enabling the fuel cells to be closed, enabling the reagent gases and the cooling fluid to be brought to the flow channels for each of these fluids, and enabling them to be collected.

1. A cell for a solid-electrolyte fuel cell of the type comprising a membrane electrode assembly disposed between two bipolar plates the cell further including:
at least one electrically-conductive spacer disposed between one of said bipolar plates and the membrane electrode assembly in such a manner as to hold the bipolar plates apart; and
the membrane electrode assembly being shaped so as to subdivide the space defined between the bipolar plates into at least one channel for passing a first gas and at least one channel for passing a second gas.

2. A fuel-cell cell according to claim 1, wherein at least one spacer is a tube for receiving a cooling fluid.

3. A fuel-cell cell according to claim 1, wherein the membrane electrode assembly is corrugated, and wherein the at least one spacer is parallel to the corrugation so as to allow at least one gas to flow parallel to the spacer.

4. A fuel-cell cell according to claim 3, wherein the at least one spacer includes in its face for co-operating with a bipolar plate at least one indentation so as to enable gas to flow perpendicularly to the spacer.

5. A fuel-cell cell according to claim 1, wherein the at least one spacer includes in its face for co-operating with the membrane electrode assembly, at least one indentation for providing a lateral flow channel under at least one spacer, and the active membrane is shaped in such a manner as to enable one gas to flow parallel to at least one spacer, and to enable the other gas to flow perpendicularly to the at least one spacer.

6. A fuel-cell cell according to claim 5, wherein the active membrane includes at least one longitudinal indentation in one direction and at least one transverse indentation in a perpendicular direction so as to enable the gas flowing perpendicularly to the at least one spacer to spread out in a space extending parallel to the at least one spacer, so as to maximize the contact area of the gas with the membrane electrode assembly.

7. A fuel-cell cell according to claim 1, wherein the membrane electrode assembly is shaped so as to create a plurality of gas flow channels.

8. A fuel-cell cell according to claim 1, wherein the bipolar plates are plane are constituted by respective sheets of an electrically-conductive metal, such as a stainless steel.

9. A solid-electrolyte fuel cell, comprising at least one fuel-cell cell according to claim 1, together with means for clamping the at least one fuel-cell cell perpendicularly to its surface, so as to provide satisfactory electrical contact at the points of contact between the bipolar plates, the spacers, and the cell.

10. A solid-electrolyte fuel cell according to claim 9, further including a peripheral frame provided with channels for allowing a first gas to flow and channels for allowing a second gas to flow, said gas-flow channels opening out into the corresponding gas flow spaces in the cells of the fuel cell, and also cooling-fluid-flow channels opening out into the tubular spacers of the cells of the fuel cell.
